(19) United States
(12) Patent Application Publication
(10) Pub. No.: US 2012/0260571 A1
(43) Pub. Date: Oct. 18, 2012

(54) VEGETATION ELEMENT FOR GREENING ARTIFICIAL OR NATURAL SURFACES HAVING LOW AND/OR HIGH PLANTS AND METHOD FOR PRODUCING THE VEGETATION ELEMENT

(75) Inventor: Wolfgang Behrens, Gross Ippener (DE)

(73) Assignee: XF TECHNOLOGIES B.V., AV Arnheim (NL)

(21) Appl. No.: 13/518,918

(22) PCT Filed: Dec. 16, 2010
(86) PCT No.: PCT/DE2010/001480

§ 371 Date: Jun. 25, 2012

(30) Foreign Application Priority Data
Feb. 11, 2010 (DE) 10 2010 007 552.3

(51) Int. Cl. A01G 9/02

(52) U.S. Cl. 47/65.7; 47/66.7

(57) ABSTRACT

A vegetation element for greening artificial surfaces having low and/or high plants. The vegetation element has a support that can be penetrated by roots, a lower layer of compressed soil, and substrate as fertile ground for the low and/or high plants. The vegetation element can be peeled by machine and can be rolled up. In the vegetation element, a film that can be penetrated by roots is arranged on the layer of compressed soil, and the support is laid on the film. A substrate layer is arranged on the support, and plant material of the low and/or high plants that is capable of germination is introduced into the substrate layer. The forming roots of the low and/or high plants extend and are anchored in the substrate layer, extending through the support and the film and into the lower layer composed of compressed soil.

The invention relates to a vegetation element for greening artificial or natural surfaces having low and/or high plants according to the preamble of claim 1 and a method for its production.

A vegetation element according to the preamble of claim 1 is already known from document EP 1 139 717 B1 from which the invention starts.

With the prior-art vegetation element it is of benefit that the technique used in the production of turf could be transferred to the field of artificial greening with dicotyledonous plants, in particular succulents with weak roots (sedum species), herbs, mosses, ferns, lichens and similar plants. It has thus become possible to produce the vegetation element inexpensively and with little labour intensity, so that the vegetation element is comparatively cheap.

The benefits described have been made possible with the prior-art vegetation element in that the native soil on which the vegetation element is cultivated is made germ-free. The native soil is generally an otherwise agriculturally used field or artificially formed and back-filled ground. Germ-free here means not only soil disinfection, as this would only kill off animal pests, in particular nematodes and microorganisms. What is particularly important is that weed seeds, weed shoots and undesirable plant elements are completely killed off.

If, with the prior-art vegetation element, the soil is not germ-free, undesirable plant species in the soil would grow up from below into the vegetation element and thus destroy the corresponding cultivation of the vegetation element. The germ-free state of the soil is therefore of great importance, particularly during the critical germination and initial growth phase of the vegetation element, as the undesirable plant species otherwise growing into the cultivation would compete with the plants of the vegetation element for the root space and the water and nutrient balance.

With the prior-art vegetation element, the soil is made chemically germ-free by gassing using a product known under the trade name of Basamid. In the meantime, however, this type of soil sterilisation using Basamid is no longer permitted in the whole of the EU, in particular because toxic gases can be released during gassing and because toxic side-effects can occur.

Although it is conceivable to work the soil mechanically in such a way that weeds are killed in order to prevent the germination of undesirable foreign seeds in the native soil, this method is very labour-intensive and time-consuming. The prohibition of the further use of Basamid means in result that the considerable advantages of the prior-art vegetation element can no longer be exploited.

The object of the invention is to create a vegetation element which is still inexpensive and requires little labour without the native soil being made germ-free. Furthermore, a method for producing a vegetation element is to be created which continues to make the technique used in the production of turf transferable to the field of artificial greening.

This object is achieved by the vegetation element according to the preamble of claim 1 by the features of the characterising portion of claim 1. The object of creating a method is achieved by the features of the characterising portion of claim 13.

According to the invention, a film that can be penetrated by roots is innovatively arranged on the layer of compressed soil and the support is laid on this film. Arranged on the support is a substrate layer into which plant material of the high and/or low plants capable of germination is introduced. After conclusion of the cultivation phase in the substrate layer, the roots of the high and/or low plants in the finished vegetation element extend through the support and through the film and into the lower layer composed of compressed soil.

A major advantage of the invention is that chemical treatment of the soil is no longer necessary to make the soil germ-free. Toxic gases can therefore no longer escape and there are also no toxic side-effects. This is achieved by the innovative use of the film which allows the soil to be essentially sterilised without the use of the harmful agent, Basamid.

The film takes away the factor light from the native soil under the film so that germination of undesirable plant species in the soil is suppressed. The film thus serves as a barrier for undesirable foreign vegetation seeds in the native soil. In addition, the film also acts as a mechanical barrier in that it hinders undesirable foreign vegetation in the native soil from growing up through the film. In result the invention creates germ-free soil just as with the prior-art vegetation element, but without the use of chemical agents. As both the film and the support can be penetrated by roots, the roots of the high and/or low plants can extend down in the desired manner into the underlying soil.

A further advantage of the invention compared with the prior-art vegetation element is that a separate soil improving substrate is no longer required, and also the mixing of the substrate under pressure with the upper layer of the soil provided for by the prior-art vegetation element can be eliminated.

In fact the use of the film creates a separation between the native soil and the applied substrate so that the pH value of the soil under the film is not negatively influenced, and the soil is available for further agricultural use.

An advantageous embodiment of the invention consists in that the film is biologically degradable, and that the rotting time of the film is set such that the film has at least rotted for the most part at the time of the mechanical harvesting of the vegetation element.

The service life of the film can be set, for example, by admixing less sensitive crude oil-based biologically degradable materials such as degradable aliphatic polyesters or polyvinyl alcohols (PVA), or plastics made from renewable raw materials, such as those based on starch, cellulose or polylactic acid (PLA).

If with the invention the rotting time of the film is set such that it has at least rotted for the most part at the time of the mechanical harvesting, the advantage is gained that the mechanical harvesting process of the vegetation element cannot be hindered by the film.

A further embodiment of the invention provides for the support to be biologically degradable. Here the rotting time is set such that the support only rots after the harvest and after laying at the new point of use of the vegetation element.

The purpose of the support is to mechanically stabilise the vegetation element and to absorb tensile forces during the harvest of the vegetation element, and also during the transport and handling at the new point of use of the finished vegetation element, e.g. during the greening of roofs. Until now the support consisting of a woven screen has been made from a synthetic material which is not biologically degradable. This creates the disadvantage that during the mechanical harvesting process of the vegetation element, residues of the synthetic material can remain in the soil causing a significant impairment of the native soil.

If with the expedient embodiment of the invention described above, the support is biologically degradable and the rotting time is set such that the support rots after the harvest and after laying at the new point of use of the vegetation element, no residues are left after laying of the vegetation element at the new point of use. Although certain residues can remain in the soil during the prior harvest, this does not create a disadvantage, as they rot. All elements—film and support—are returned to the natural cycle due to their biological degradability. As the support has not yet rotted at the time of the harvest, however, it can fulfil its function and provide mechanical stabilisation and an increase in the tensile strength.

The assurance of the tensile strength of the vegetation element during the harvest is necessary as some of the plants used, such as sedum, form a less dense and flatter root ball, so that the roots do not penetrate the substrate sufficiently to ensure adequate stability of the vegetation element during the harvesting process.

According to another advantageous embodiment, the support is formed by a net, a woven screen, a random laid layer or a fibre blend. These embodiments ensure that the support can serve particularly well as an anchoring point for the roots of the low and/or high plants. In addition, the vegetation element is also given an adequate tensile strength.

Another advantageous embodiment of the invention consists in that the film is perforated. As a result, the perforated film is water permeable to a certain extent at various points so that excess water can seep through the perforation into the native soil and harmful accumulations of water are avoided. Excess water can be caused by rain or the use of sprinklers for irrigation. In addition the perforation of the film allows the low and/or high plants to root down even better through the film into the native soil.

A further advantageous embodiment of the invention provides for the film and the support to be joined to one another to form a unit. For this purpose the film and support can be quilted to one another. This simplifies the application of the film and the woven screen on the compressed soil because only one unit of film and support has to be installed instead of two individual parts.

A further advantageous embodiment of the invention provides for a claw layer, in which the substrate layer is located, to be arranged on the support. The claw layer known per se can consist of an ultraviolet light-resistant woven plastic fabric or of woven coconut fibres. The claw layer prevents the substrate layer being shifted, washed away or eroded by water and wind.

A further advantageous embodiment of the invention consists in the film, the support and the claw layer being joined together to form a composite. This simplifies the application of the three components film, support and claw layer on the compressed soil. In addition, the application of the three components is independent of windless conditions during the installation in the field.

According to a further advantageous embodiment of the invention, a dry adhesive is admixed to the substrate layer. The dry adhesive can be used as an alternative to the claw layer and serves in the same way as the claw layer to protect the substrate layer against erosion.

An inventive method for producing the vegetation element according to claim 1 is characterised by the following process steps:

a) Native soil serving as a culture base is compressed so that a layer of compressed soil is created,

b) A film that can be penetrated by roots is placed on the layer of compressed soil,

c). A support that can be penetrated by roots is placed on the film,

d) Substrate is poured onto the support to form a substrate layer which serves as a seed bed for the low and/or high plants,

e) Plant material of the low and/or high plants capable of germination is sown in or scattered on the substrate layer,

f) The vegetation element thus created is cared for horticulturally until the low and/or high plants have formed,

g) The vegetation element is peeled and harvested by machine.

Process step b) in which a film that can be penetrated by roots is placed on the layer of compressed soil is of particular importance. Since with the invention the process of making the native soil germ-free using chemical means is deliberately omitted, it has to be assumed that there are undesirable plant residues and foreign vegetation seeds in the native soil. The film takes away the factor light from the undesirable plant seeds in the native soil so that successful germination of the undesirable plant seeds is prevented, and hence no undesirable plants can grow through from below into the vegetation element. In addition, the film also acts as a mechanical barrier in that it prevents any undesirable plants from growing up through the film. As the film is designed to allow roots to grow through, the roots of the desired low and/or high plants can nevertheless extend through the film down into the underlying native soil.

A further inventive method for producing a vegetation element according to claim 1 provides for a unit, consisting of a film that can be penetrated by roots and a support that can be penetrated by roots, being placed on the layer of compressed soil. The other process steps as described in claim 13 remain unchanged. The use of the unit simplifies the installation in the field and on the native soil.

Finally a further inventive method for producing a vegetation element according to claim 1 provides for a composite, consisting of a film that can be penetrated by roots, a support that can be penetrated by roots and a claw layer, being placed on the layer of compressed soil. Substrate is introduced into the claw layer to form a substrate layer which serves as a seed bed for the low and/or high plants, The other process steps as described in claim 13 are retained. The claw layer protects the substrate layer against erosion. Furthermore, the composite considerably simplifies the application of the three components film, support and claw layer, and the application is furthermore independent of whether or not windless conditions prevail during the application.

The invention is described in greater detail below by reference to the embodiments shown in the drawing:

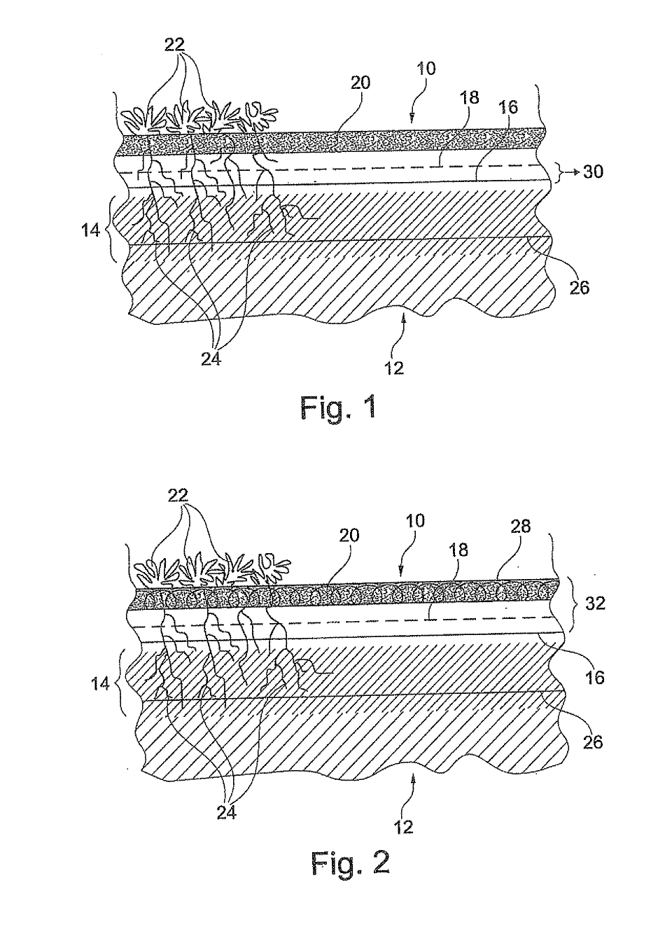

FIG. 1 shows a schematic cross-sectional view of a first embodiment of an inventive vegetation element, and

FIG. 2 shows a schematic cross-sectional view of a second embodiment of an inventive vegetation element.

The vegetation element 10 in FIG. 1 comprises several layers which for better illustration are shown separately at a distance from one another. First native soil 12 is compressed so that a layer of compressed soil 14 is created. The compressing of the native soil 12 is carried out to ensure that the soil can be driven over during the later harvest by a corresponding harvesting machine.

A film 16 that can be penetrated by roots is placed onto the compressed soil 14 and a support 18 is arranged on the film 16. The film 16 is perforated and hence to a certain extent water permeable and can in the normal manner be a film with organic or inorganic substances. The support 18, for example, is formed by a PP net. Finally a substrate layer 20 which serves as a seed bed for the high and/or low plants 22 is also applied to the support 18. The thickness of the substrate layer lies between 0.5 cm and 5.0 cm.

The substrate layer 20 consists of an air-permeable mineral mixture to which organic substances have been added, depending on the type of plants used. Plant material of the low and/or high plants capable of germination is sown in the substrate layer 20 or scattered on the substrate layer 20.

The vegetation element 10 is then cared for horticulturally until the high and/or low plants 22 have formed. The roots 24 of the high and/or low plants 22 extend in the substrate layer 20, through the support 18 and through the film 16 and into the compressed soil 14. When the vegetation element 10 is ready after the horticultural care, it is harvested along a parting line 26 in a manner known per se by removing the vegetation element 10 from the soil 12 using a peeling blade (not illustrated) along the parting line 26 and rolling it up. The resulting rolls are then transported to a desired point of use to be used, for example, for greening a roof with the vegetation element 10.

In FIG. 1 the film 16 and the support 18 are joined together to form a unit 30 so that the two elements, support 18 and film 16, can be laid on the compressed soil 14 in one work process.

The vegetation element 10 shown in FIG. 2 corresponds essentially to the vegetation element 10 in FIG. 1. In FIG. 2, however, a claw layer 28 in which the substrate layer 20 is located is additionally provided on the support 18. The film 16, support 18 and claw layer 28 are joined to one another, for example quilted together, and form a composite 32 which can be laid on the compressed soil 14 in one work process. The claw layer 28 protects the substrate layer 20 contained therein against erosion.

It is expedient for the film 16 to slightly overlap the support 18 at least in the longitudinal direction. This ensures that when the strips of the vegetation element 10 are laid alongside one another, the film 16 always forms a closed layer so that no undesirable plants or weeds can grow up out of the soil 12.

In both FIG. 1 and FIG. 2, the film 16 that can be penetrated by roots and the support 18 that can be penetrated by roots are biologically degradable. The elements film 16 and support 18 are thus returned to the natural cycle after rotting when they have fulfilled their intended function.

### LIST OF REFERENCE NUMBERS

(forms part of the description)
10 Vegetation element
12 Native soil
14 Compressed soil
16 Film
18 Support
20 Substrate layer
22 Plants
24 Roots
26 Parting line
28 Claw layer
30 Unit
32 Composite

1. A vegetation element for greening artificial or natural surfaces having low and/or high plants, with a support that can be penetrated by roots and with a lower layer of compressed soil and with substrate as fertile ground for the low and/or high plants, wherein the vegetation element can be peeled by machine and can be rolled up, and wherein a film that can be penetrated by roots is arranged on the layer of compressed soil, the support is laid on the film, a substrate layer is arranged on the support, plant material of the low and/or high plants capable of germination is introduced into the substrate layer, and the forming roots of the low and/or high plants extend and are anchored in the substrate layer, through the support and the film and in the lower layer composed of compressed soil.

2. The vegetation element according to claim 1, wherein the film is biologically degradable, and the rotting time of the film is set such that the film has at least rotted for the most part at the time of the mechanical harvesting.

3. The vegetation element according to claim 1, wherein the support is biologically degradable, and the rotting time of the support is set such that the support rots after the harvest and after laying at the new point of use of the vegetation element.

4. The vegetation element according to claim 1, wherein the support is a net, a woven screen, a random laid layer or a fibre blend.

5. The vegetation element according to claim 1, wherein the film is perforated.

6. The vegetation element according to claim 1, wherein the film and the support are joined together to form a unit.

7. The vegetation element according to claim 1, wherein the substrate layer is located in a claw layer, and the claw layer is arranged on the support.

8. The vegetation element according to claim 7, wherein the film, the support, and the claw layer are joined together to form a composite.

9. The vegetation element according to claim 1, wherein the substrate layer is 0.5 cm to 5 cm thick.

10. The vegetation element according to claim 1, wherein a dry adhesive is admixed to the substrate layer.

11. The vegetation element according to claim 1, wherein the substrate layer is formed by an air-permeable mineral mixture that forms the fertile ground for the low and/or high plants and that is free from foreign seed matter.

12. The vegetation element according to claim 11, wherein organic constituents have been added to the mineral mixture.

13. A method for producing a vegetation element according to claim 1, wherein:
a) native soil serving as a culture base is compressed so that a layer of compressed soil is created,
b) A film that can be penetrated by roots is placed on the layer of compressed soil,
c) A support that can be penetrated by roots is placed on the film,
d) Substrate is poured onto the support to form a substrate layer which serves as a seed bed for the low and/or high plants,
e) Plant material of the low and/or high plants capable of germination is sown in or scattered on the substrate layer,
f) The vegetation element thus created is cared for horticulturally until the low and/or high plants have formed,
g) The vegetation element is peeled and harvested by machine.

14. A method for producing a vegetation element according to claim 1, wherein:
a) Native soil serving as a culture base is compressed so that a layer of compressed soil is created;
b) A unit, comprising a film that can be penetrated by roots and a support that can be penetrated by roots, is placed on the layer of compressed soil;
c) Substrate is poured onto the support of the unit to form a substrate layer that serves as a seed bed for the low and/or high plants;
d) Plant material of the low and/or high plants capable of germination is sown in or scattered on the substrate layer;
e) The vegetation element thus created is cared for horticulturally until the low and/or high plants have formed;
f) The vegetation element is peeled and harvested by machine.

15. A method for producing a vegetation clement according to claim 1, wherein:
a) Native soil serving as a culture base is compressed so that a layer of compressed soil is created;
b) A composite, comprising a film that can be penetrated by roots, a support that can be penetrated by roots, and a claw layer, is placed on the layer of compressed soil;
c) Substrate is introduced into the claw layer to form a substrate layer that serves as a seed bed for the low and/or high plants;
d) Plant material of the low and/or high plants capable of germination is sown in or scattered on the substrate layer;
e) The vegetation element thus created is cared for horticulturally until the low and/or high plants have formed,
f) The vegetation element is peeled and harvested by machine.
